(19) United States
(12) Patent Application Publication
(10) Pub. No.: US 2026/0166682 A1
(43) Pub. Date: Jun. 18, 2026

(54) MULTIFUNCTIONAL WRENCH

(71) Applicant: TECHTRONIC CORDLESS GP, Anderson, SC (US)

(72) Inventors: Rui DAI, Dongguan City (CN); Jasmin PODZIMSKI, Baden-Württemberg (DE); Raphael SCHÜTT, Baden-Württemberg (DE)

(21) Appl. No.: 19/417,766

(22) Filed: Dec. 12, 2025

(30) Foreign Application Priority Data
Dec. 13, 2024 (CN) 202423089601.2

(51) Int. Cl. B25B 13/06; B25B 23/16; B25F 1/02

(52) U.S. Cl. CPC B25B 13/06; B25B 23/16; B25F 1/02

(57) ABSTRACT

The utility model relates to a multifunctional wrench, comprising: a generally L-shaped driving rod body including a first driving rod section, a second driving rod section, and a bent section connecting the first and second driving rod sections; a handle body extending in a longitudinal direction, the handle body being fixed to the driving rod body at the bent section, wherein the first driving rod section extends beyond the handle body in the longitudinal direction; the metal end cap is arranged at one end, opposite to the first driving rod section, of the handle body in the longitudinal direction, and the reinforcing block is connected with the metal end cap and the driving rod body.

### FIELD OF THE INVENTION

The utility model relates to the technical field of wrenches, in particular to a multifunctional wrench.

### BACKGROUND

A screw is a common fastener and is widely applied to the fields of various mechanical equipments, buildings, electronic products and the like. There are various shapes and the types of the screws, so as to meet different requirements for use. Hexagonal screws with hexagonal heads are one of the most common types of screws. Because of the six planes, the screw can be fastened by using tools such as a wrench, a sleeve and the like, and a large rotating force is provided by the tools. The hexagon screw is generally used for occasions requiring higher torque, such as mechanical equipments, large-scale engineering constructions and the like. Hex screws have good stability and resistance to loosening, which is commonly used in high strength applications. The head of the inner hexagon screw is in a hexagon concave shape, and an inner hexagon wrench can be used for fastening. The design of the screw can provide high torque transmission capacity, and the head is compact in shape and suitable for places with limited space. Socket head cap screws are widely used in precision equipments, mechanical assemblies, and electronic equipments. Some automotive or mechanical devices use hexagram screws to reinforce certain important or valuable components, particularly to avoid damage from ordinary tool removal or to reduce non-professional intervention.

Multifunctional wrenches are used to tighten or loosen screws or bolts, such as hex screws, socket head cap screws, hexagram screws, and the like. The wrench comprises an inner hexagon wrench, a hexagonal wrench, a hexagram wrench and the like. The multifunctional wrench is a common tool for tightening or loosening internal hexagonal screws, hexagram screws and the like in life or work. Multifunctional wrenches are typically L-shaped or T-shaped. The L-wrench has two arms of different lengths that can provide different torques and angles of rotation so as to permit the user to select which arm to be held as desired. The T-shaped wrench is suitable for occasions requiring larger torque, and is provided with a relatively straight handle, so that better operation control can be provided.

After the screw is used for a long time and exposed to moisture, dust or corrosive substances, abrasion, corrosion, damage and the like can occur to the screw, so that the disassembly process is negatively influenced, and even the operation for loosening the screw cannot be realized. Rusted or damaged screws may make it difficult for the multifunctional wrench to engage the screw head. Especially when the shape of the screw head changes (e.g. due to rust, wear or deformation), the contact surfaces of the multifunctional wrench no longer match the head of the screw, resulting in an inability to firmly grip the screw. One common solution is to use a hammer to strike the other end of the screw or bolt to loosen the screw or bolt so that it can be easily unscrewed by means of a wrench for disassembly. However, this requires the use of an additional hammer, which means that the screw cannot be removed with the multifunctional wrench without a hammer on hand, because the grip portion of the multifunctional wrench is usually made of plastic, and the wrench cannot strike the screw by itself, and it cannot meet the user's requirements for loosening the screw.

Accordingly, there is a need in the art to provide a multifunctional wrench that can be used not only to tighten or loosen a fastener such as a screw or bolt, but also as can be used as a hammer, for example, to strike the fastener or the other end of the fastener to loosen the fastener in the event that the fastener is difficult to be loosened, so that the fastener can be easily loosened by the wrench for disassembly.

### SUMMARY

One of the objects of the utility model is to provide a multifunctional wrench which can also be used as a hammer to strike a fastener or the other end of the fastener to loosen the fastener in the case where the fastener is difficult to be loosened, so that the fastener can be easily loosened by the multifunctional wrench for disassembly.

According to an aspect of the utility model, there is provided a multifunctional wrench including:
a generally L-shaped driving rod body including a first driving rod section, a second driving rod section, and a bent section connecting the first and second driving rod sections;
a handle body extending in a longitudinal direction, the handle body being fixed to the driving rod body at the bent section, wherein the first driving rod section extends beyond the handle body in the longitudinal direction;
a metal end cap which is provided on an end of the handle body opposite the first driving rod section in the longitudinal direction; and
an reinforcing block which is connected with the metal end cap and the driving rod body.

In one aspect of the utility model, the reinforcing block includes a recess recessed from one side, the recess being configured to receive the driving rod body, preferably the recess is an L-shaped recess, and preferably, the L-shaped recess has a depth greater than the maximum outer diameter of the driving rod body.

In another aspect of the utility model, the handle body is provided with a blind bore in which is provided a bore shoulder, and the metal end cap includes a longitudinally extending plug portion, and the plug portion is provided with a collar groove which is arranged to receive the bore shoulder when the metal end cap is positioned in the blind bore.

In another aspect of the utility model, the driving rod body extends through the reinforcing block and the bent section is located inside the reinforcing block.

In another aspect of the utility model, the reinforcing block comprises two halves, each half comprising a half channel for receiving the driving rod body, the two halves being fixed together by fasteners, and preferably the handle body is overmolded onto the reinforcing block and driving rod body.

In another aspect of the utility model, the reinforcing block includes a protrusion extending in a longitudinal direction, the protrusion being configured to be connected to the metal end cap.

In another aspect of the utility model, the metal end cap includes a longitudinally extending plug portion which is formed to have a hollow interior into which the protrusion is insertable, and preferably the plug portion forms an outwardly flared flare at an open end.

In another aspect of the utility model, the length of the protrusion is less than or equal to the length of the hollow interior of the plug portion.

In another aspect of the utility model, the end of the driving rod body is in the shape of a regular hexagon, an inner hexagonal socket, or a hexagram.

In another aspect of the utility model, the end of the driving rod body and/or the metal end cap are magnetic.

In another aspect of the utility model, the strength of the metal end cap is greater than or equal to the strength of the reinforcing block.

In another aspect of the utility model, the metal end cap and the reinforcing block are formed as one piece.

In the utility model, the multifunctional wrench includes a metal end cap provided at one end of a handle body, and the multifunctional wrench can also be used as a hammer to strike a fastener or the other end of the fastener to loosen the fastener in the case where the fastener is difficult to be loosened, so that the fastener can be easily loosened by the multifunctional wrench for disassembly.

### BRIEF DESCRIPTION OF THE FIGURES

The objects and features of the utility model will become apparent from the following detailed description considered in conjunction with the accompanying drawings. It is to be understood, however, that the drawings are designed solely for the purposes of illustration and not as a limitation of the utility model.

FIG. 1 shows a perspective view of a multifunctional wrench according to one embodiment of the utility model;

FIG. 2 shows an exploded perspective view of the multifunctional wrench according to one embodiment of the utility model;

FIG. 3 shows a longitudinal cross-sectional view of a multifunctional wrench according to one embodiment of the utility model;

FIG. 4 shows an exploded perspective view of a portion of the multifunctional wrench according to one embodiment of the utility model, wherein an reinforcing block is shown to be assembled to a driving rod body;

FIG. 5 shows a perspective view from another angle of the reinforcing block of the multifunctional wrench according to one embodiment of the utility model;

FIG. 6 shows a longitudinal cross-sectional view of a handle body of a multifunctional wrench according to one embodiment of the utility model;

FIG. 7 shows a perspective view of a metal end cap of the multifunctional wrench in accordance with one embodiment of the utility model;

FIG. 8 shows a perspective view of a driving rod body of a multifunctional wrench in accordance with one embodiment of the utility model;

FIG. 9 shows a perspective view of a driving rod body of a multifunctional wrench according to another embodiment of the utility model; and

FIG. 10 shows a perspective view of a driving rod body of a multifunctional wrench according to yet another embodiment of the utility model.

### DETAILED DESCRIPTION

The technical solutions of the utility model will be described clearly and completely with reference to the accompanying drawings, and it is to be understood that the described embodiments are only a part of the embodiments of the utility model, and not all of the embodiments. All other embodiments, which can be obtained by a person skilled in the art without making any creative effort based on the embodiments in the utility model, belong to the protection scopes of the utility model.

In the illustration of the utility model, it should be noted that, unless otherwise explicitly specified or limited, the term “connected” or the like is to be interpreted broadly, and may be, for example, a fixed connection, a detachable connection, or an integral connection; can be mechanically or electrically connected; may be directly connected or indirectly connected through intermediate part(s). The specific meanings of the above terms in the utility model can be understood to those of ordinary skill in the art based on the specific situation. In addition, in the illustration of the utility model, “a plurality” means two or more, unless otherwise specified. It will also be understood that the terms “central,” “longitudinal,” “lateral,” “upper,” “lower,” “front,” “rear,” “left,” “right,” “vertical,” “horizontal,” “top,” “bottom,” “inner,” “outer,” “axial,” “radial,” “circumferential”, and the like are used in an orientation or positional relationship indicated in the drawings for convenience in describing the utility model and simplifying the description, but do not indicate or imply that the device or element so referred to must have a particular orientation, be constructed and operated in a particular orientation, and are not to be construed as limiting the utility model.

In the illustration of the specification, reference to the illustration of “one embodiment,” “some embodiments,” “an example,” “a specific example,” or “some examples” or the like means that a particular feature, structure, material, or characteristics described in connection with the embodiment or example is included in at least one embodiment or example of the utility model. In this specification, schematic representations of the terms do not necessarily refer to the same embodiment or example. Furthermore, the particular features, structures, materials, or characteristics described may be combined in any suitable manner in any one or more embodiments or examples.

To facilitate understanding of the utility model by those skilled in the art, reference will now be made to the drawings in which the same reference numerals refer to the same or like elements.

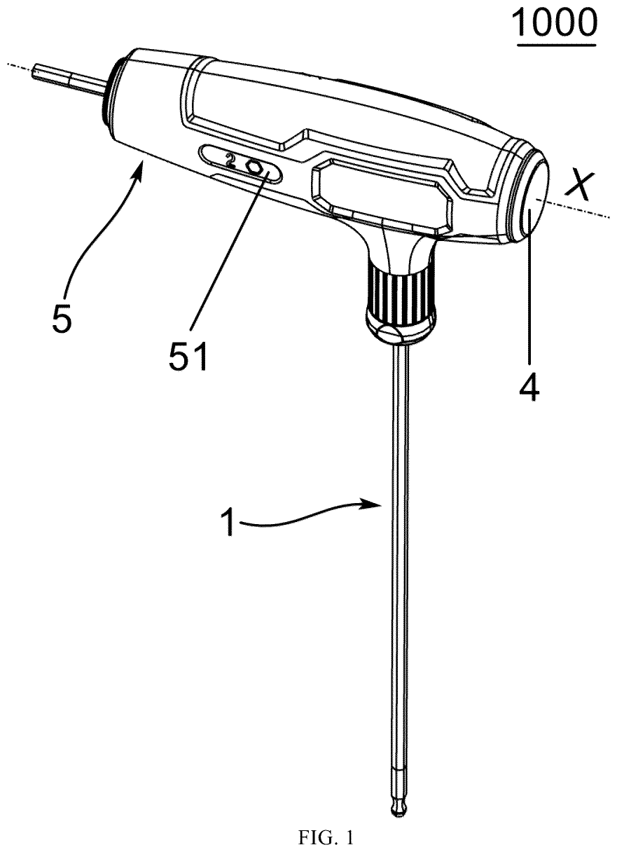

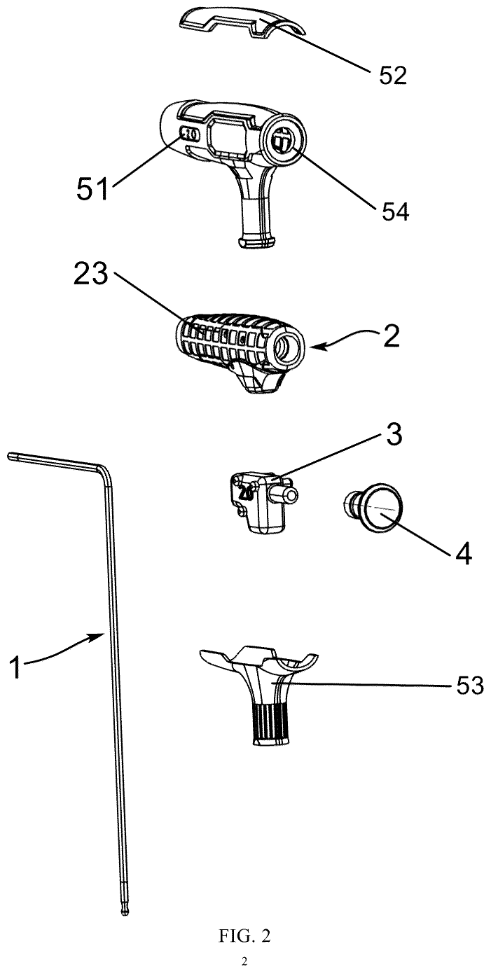

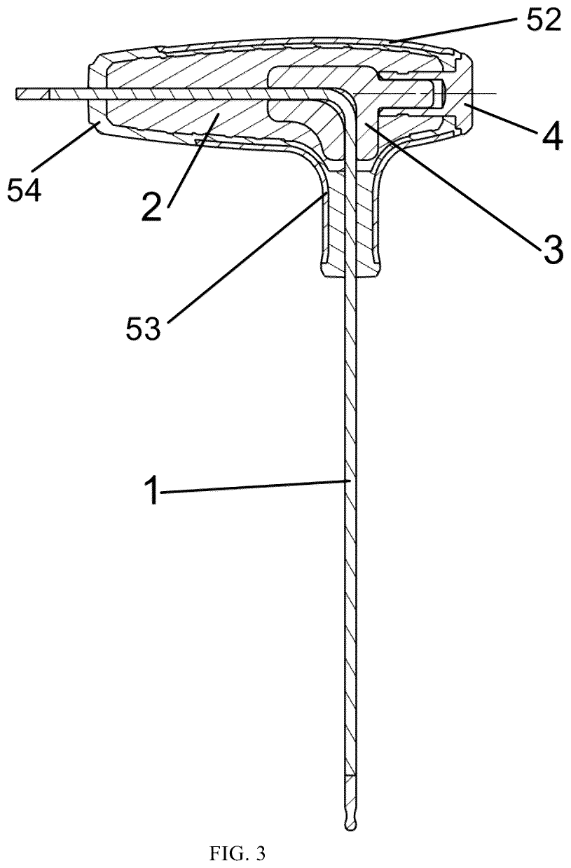

FIG. 1 shows a perspective view of a multifunctional wrench 1000 according to one embodiment of the utility model. FIG. 2 shows an exploded perspective view of a multifunctional wrench 1000 according to one embodiment of the utility model. FIG. 3 shows a longitudinal cross-sectional view of a multifunctional wrench 1000 according to one embodiment of the utility model. In one embodiment of the utility model, the multifunctional wrench 1000 includes a driving rod body 1 and a handle body 2. The multifunctional wrench 1000 is configured to engage the driving rod body 1 with an object to be tightened or loosened (e.g., a screw or a bolt), and gripped by a user on the handle body 2 to apply a rotational torque to tighten or loosen the object.

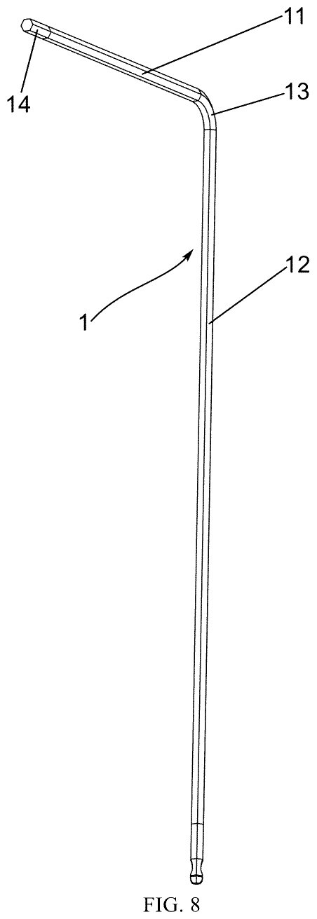

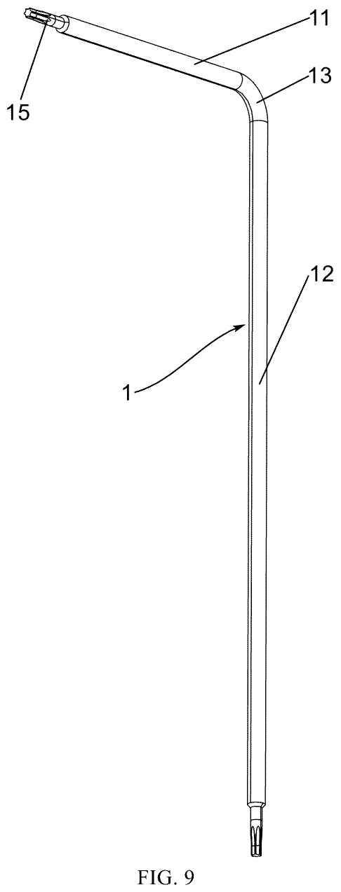

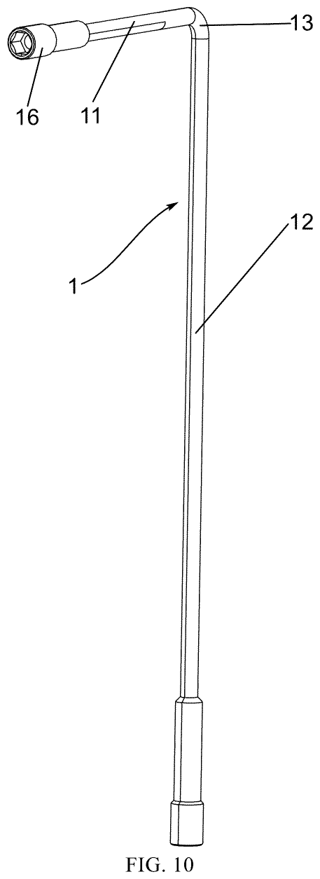

FIG. 8 shows a perspective view of the driving rod body 1 of the multifunctional wrench 1000 according to one embodiment of the utility model. As shown in FIG. 8, the driving rod body 1 is substantially L-shaped, including a first driving rod section 11, a second driving rod section 12, and a bent section 13 connecting the first and second driving rod sections 11 and 12. In one embodiment, the first driving rod section 11 has a first length, and the second driving rod section 12 has a second length greater than the first length. In one embodiment of the utility model, the driving rod body 1 is provided as one piece. The end of the driving rod body 1 can be manufactured with different shapes for driving screws or bolts having different shapes. For example, in FIG. 8, the end 14 of the driving rod body 1 is manufactured with a hexagonal shape for screwing or unscrewing a hex socket cap screw or bolt. FIG. 9 shows a perspective view of a driving rod body 1 of a multifunctional wrench 1000 according to another embodiment of the utility model. As shown in FIG. 9, the end 15 of the driving rod body 1 is manufactured with a hexagram shape for screwing or unscrewing a hexagon socket screw or bolt. FIG. 10 shows a perspective view of a driving rod body 1 of a multifunctional wrench 1000 according to yet another embodiment of the utility model. As shown in FIG. 10, the end 16 of the driving rod body 1 is manufactured with a shape of an inner hexagonal socket for tightening or loosening a hexagonal screw or bolt. In one embodiment, the end of the driving rod body 1 can be equipped with a replaceable adapter by which a variety of different sizes and types of screwdriver bits can be coupled or mounted to engage with various sizes of screws or bolts. In one embodiment, the end of the driving rod body 1 is magnetic to facilitate magnetic attraction of a fastener such as a screw or bolt.

As shown in FIGS. 1 to 3, in one embodiment of the utility model, the multifunctional wrench 1000 comprises a handle body 2 extending along a longitudinal direction X. The handle body 2 is fixed to the driving rod body 1 at the bent section 13, wherein the first driving rod section 11 extends beyond the handle body 2 along the longitudinal direction X. In one embodiment of the utility model, the multifunctional wrench 1000 further comprises an end cap 4. The end cap is preferably a metal end cap 4, and the metal end cap 4 is arranged on an end of the handle body 2 opposite to the first driving rod section 11 in the longitudinal direction X. In the embodiment of FIG. 1, the metal end cap 4 is provided at the rear end. The metal end cap is made of a high strength, low alloy steel, such as the well known 50BV30, which is capable of withstanding large loads and impacts. In one embodiment, additional impact force may be applied by striking on the metal end cap via a hammer. In one embodiment, the strength of the metal end cap is greater than or equal to the strength of the reinforcing block.

In the embodiment as shown in FIGS. 1-3, the multifunctional wrench 1000 may further include a reinforcing block 3, and the reinforcing block 3 connects the metal end cap 4 and the driving rod body 1. In one embodiment, the driving rod body 1 extends through the reinforcing block 3 and the bent section 13 is located inside the reinforcing block 3. The reinforcing block 3 is arranged inside the handle body 2. In one embodiment, the reinforcing block 3 is made of a hard metal or alloy thereof, preferably a medium carbon steel such as the well-known 45 steel, to further increase the torsional strength of the multifunctional wrench 1000.

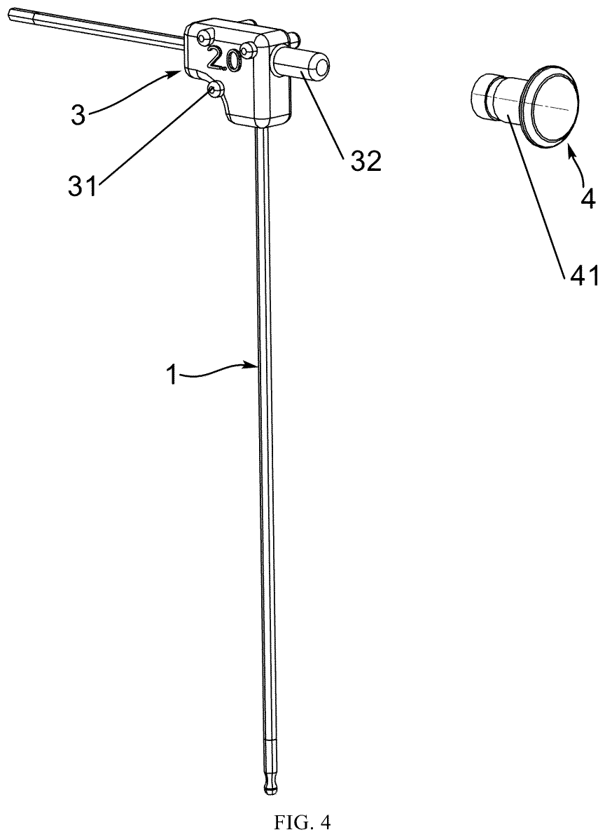

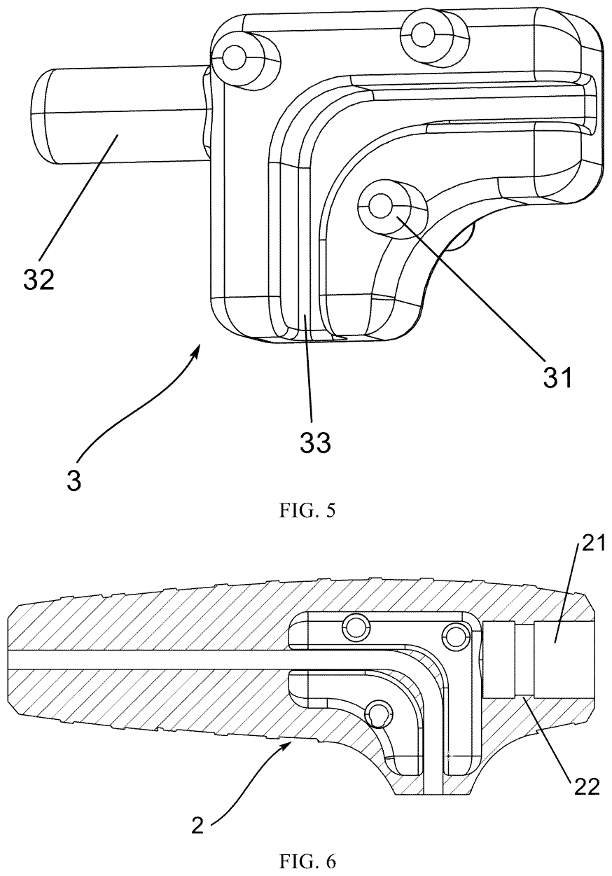

FIG. 4 shows an exploded perspective view of a portion of a multifunctional wrench 1000 according to one embodiment of the utility model, wherein the reinforcing block 3 is shown to be assembled to the driving rod body 1, but the metal end cap 4 is not yet assembled together. FIG. 5 shows a perspective view from another angle of the reinforcing block 3 of the multifunctional wrench 1000 according to an embodiment of the utility model. In one embodiment, as shown in FIG. 5, the reinforcing block 3 can be provided as one piece, with a recessed, preferably L-shaped recess 33 being formed on one side thereof for receiving the driving rod body 1, wherein the bent section 13 of the driving rod body 1 is received in the L-shaped recess 33. In one embodiment, the L-shaped recess 33 is recessed in a depth more than half the thickness of the reinforcing block 3. In one embodiment, the depth of the L-shaped recess 33 is greater than the maximum outer diameter of the driving rod body 1. In one embodiment, as shown in FIG. 5, the reinforcing block 3 comprises a positioning element 31, such as a pin, for determining the position of the reinforcing block 3 when overmolding the handle body 2. On each side of said reinforcing block 3, preferably 3 positioning elements 31 are provided to ensure that the reinforcing block 3 is in place during overmolding. In an alternative embodiment, the reinforcing block 3 comprises two halves, each half comprising a half channel for receiving the driving rod body 1, and the two halves are fixed together by fasteners (e.g. screws). In one embodiment, the reinforcing block 3 comprises two pieces that can be disassembled to facilitate mounting of the driving rod body 1 thereto, and the two pieces can be fixedly connected together to keep the reinforcing block 3 fixed relative to the driving rod body 1.

In one embodiment, the reinforcing block 3 further comprises a protrusion 32 extending in the longitudinal direction. In one embodiment, as shown in FIG. 4, the protrusion 32 extends rearwardly from the body of the reinforcing block 3 for receiving a metal end cap 4, as will be described later. In one embodiment, after the reinforcing block 3 is assembled to the driving rod body 1 and the metal end cap 4 is connected to the protrusion 32 of the reinforcing block 3, they all are placed in a mold, the handle body 2 is overmolded thereon to securely fix the driving rod body 1, the reinforcing block 3 and the metal end cap 4 to the handle body 2.

In one embodiment, the multifunctional wrench 1000 optionally includes a handle housing 5. The handle housing 5 is configured to be wrapped over the handle body 2, thereby increasing the gripping area of the handle and optionally forming a more grip-convenient shape to further increase the user's comfort during use. In one embodiment, the outer surface of the handle body 2 is provided with relieves 23 to increase friction between the handle body 2 and the handle housing 5. In one embodiment, an indicator 51 is provided on the handle housing 5 to indicate the type of wrench 1000 for the user. For example, as shown in FIG. 1, the indicator 51 indicates to the user that the end of the driving rod body of the wrench is a 2-hexagon, indicating that the multifunctional wrench 1000 is a 2 mm-hexagon wrench. In one embodiment, the handle housing 5 optionally includes a housing body 54, an upper housing cover 52, and a lower housing cover 53. The upper housing cover 6 is disposed on a top surface of the housing body 54, and the lower housing cover 53 is disposed at a lower portion of the housing body 54. In one embodiment, the housing body 54, the upper housing cover 52 and the lower housing cover 53 are co-molded and/or separately molded by means of three different materials. In one embodiment, the outer surface of the handle housing 5 is textured to increase friction when the user grips the multifunctional wrench 1000.

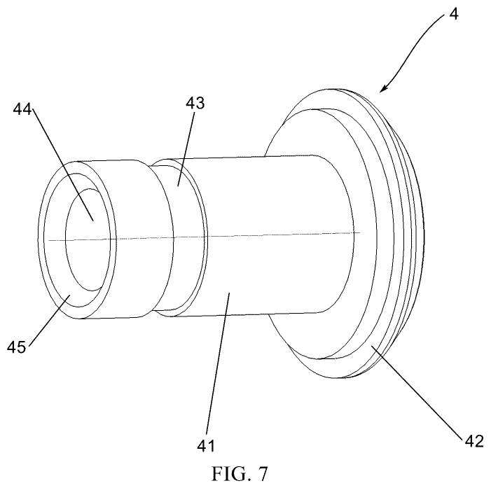

FIG. 6 shows a longitudinal cross-sectional view of the handle body 2 of the multifunctional wrench 1000 according to one embodiment of the utility model. In one embodiment, the interior of the handle body 2 is formed in a shape complementary to the driving rod body 1, the reinforcing block 3 and the metal end cap 4. Thereby, the driving rod body 1, the reinforcing block 3 and the metal end cap 4 are integrally formed with the handle body 2 after the handle body 2 is overmolded. In another embodiment, the handle body 2 is overmolded only onto the driving rod body 1 and the reinforcing block 3, and the handle body 2 is molded to include a blind bore 21, and the metal end cap 4 is separately manufactured and configured to be plugged into the blind bore 21. In one embodiment, a bore shoulder 22 is provided in the blind bore 21 for preventing the metal end cap 4 from sliding out in the longitudinal direction X after the metal end cap 4 is plugged into the blind bore 21, as will be described below.

FIG. 7 shows a perspective view of the metal end cap 4 of the multifunctional wrench 1000 in accordance with one embodiment of the utility model. The metal end cap 4 includes a longitudinally extending plug portion 41 and a cap portion 42. The cap portion 42 is generally circular to close the blind bore 21 when the metal end cap 4 is inserted into the blind bore 21. In addition, when the multifunctional wrench 1000 is used as a hammer for striking, the cap portion 42 is used as a hammer head, and the cap portion 42 has a large surface, providing a large area for striking, thereby reducing the risk of mis-striking and ensuring safety for the user. Since the metal end cap 4 is made of high-strength low alloy steel, it can withstand repeated striking, which significantly improves the durability of the multifunctional wrench 1000.

As shown in FIG. 7, the plug portion 41 is provided with a collar groove 43, the collar groove 43 being arranged to receive the bore shoulder 22 to prevent the metal end cap 4 from sliding out or falling out of the handle body 2 in the longitudinal direction X. In the embodiment where the handle body 2 is only overmolded to the driving rod body 1 and the reinforcing block 3, the metal end cap 4 is configured to be plugged into the blind bore 21, and the collar groove 43 is configured to receive the bore shoulder 22 when the metal end cap 4 is inserted into the blind bore 21, so as to prevent the metal end cap 4 from sliding out in the longitudinal direction X. In one embodiment, the cap portion 42 is magnetic to facilitate the attraction of components or fasteners such as screws or bolts. In one embodiment, the plug portion 41 is formed as a collar having a hollow interior 44, and the protrusion 32 of the reinforcing block 3 is configured to be insertable into the hollow interior 44 of the collar. In another embodiment, the hollow interior 44 can be provided with an internal thread, and the protrusion 32 is provided with an external thread, and the reinforcing block 3 can be connected with the metal end cap 4 by means of the threaded engagement of the protrusion 32 and the hollow interior 44. In one embodiment, the length of the protrusion 32 is less than or equal to the length of the hollow interior 44 of the collar, so that the free end of the metal end cap 4 can abut the reinforcing block. That is, the metal end cap 4 can be abutted against the reinforcing block 3 and can withstand a large impact force at the time of striking. In one embodiment, as shown in FIG. 7, the plug portion 41 is formed with an outwardly flared flare 45 at the open end, the flare 45 helping to more easily guide the protrusion 32 into the hollow interior 44, thereby facilitating the plugging of the metal end cap 4 onto the protrusion 32 of the reinforcing block 3. In one embodiment, the metal end cap 4 and the reinforcing block 3 may be provided as one piece.

In the utility model, the multifunctional wrench 1000 includes the metal end cap 4 provided at one end of the handle body 2, and the multifunctional wrench can also be used as a hammer to strike the fastener or the other end of the fastener to loosen the fastener in the case where the fastener is difficult to be unscrewed, so that the fastener can be easily unscrewed by the multifunctional wrench for disassembly.

Although the present specification describes several embodiments, not every embodiment includes only a single embodiment, and such illustrations are provided for clarity, and it is understood that the specification is incorporated herein by reference, and the solutions described in each embodiment may be combined as appropriate to form other embodiments, which will be apparent to those skilled in the art. The scope of the utility model is defined by the appended claims, rather than defined by the foregoing description, and all changes that come within the meaning and range of equivalency of the claims are therefore within the utility model.

It will be evident to those skilled in the art that the utility model is not limited to the details of the foregoing illustrative embodiments, and that the utility model may be embodied in other specific forms without departing from the spirit or essential attributes thereof. Accordingly, the above-described embodiments should be regarded as illustrative, and not restrictive.

1. A multifunctional wrench, comprising:
a generally L-shaped driving rod body including a first driving rod section, a second driving rod section, and a bent section connecting the first and second driving rod sections;
a handle body extending in a longitudinal direction, the handle body being fixed to the driving rod body at the bent section, wherein the first driving rod section extends beyond the handle body in the longitudinal direction;
a metal end cap which is provided on an end of the handle body opposite the first driving rod section in the longitudinal direction; and
an reinforcing block which is connected with the metal end cap and the driving rod body.

2. The multifunctional wrench of claim 1, wherein the reinforcing block includes a recess recessed from one side, the recess being configured to receive the driving rod body, preferably the recess is an L-shaped recess, and preferably, the L-shaped recess has a depth greater than the maximum outer diameter of the driving rod body.

3. The multifunctional wrench of claim 1, wherein the handle body is provided with a blind bore in which is provided a bore shoulder, and the metal end cap includes a longitudinally extending plug portion, and the plug portion is provided with a collar groove which is arranged to receive the bore shoulder when the metal end cap is positioned in the blind bore.

4. The multifunctional wrench of claim 1, wherein the driving rod body extends through the reinforcing block and the bent section is located inside the reinforcing block.

5. The multifunctional wrench of claim 1, wherein the reinforcing block comprises two halves, each half comprising a half channel for receiving the driving rod body, the two halves being fixed together by fasteners, and preferably the handle body is overmolded onto the reinforcing block and driving rod body.

6. The multifunctional wrench of claim 1 wherein the reinforcing block includes a protrusion extending in a longitudinal direction, the protrusion being configured to be connected to the metal end cap.

7. The multifunctional wrench of claim 6, wherein the metal end cap includes a longitudinally extending plug portion which is formed to have a hollow interior into which the protrusion is insertable, and preferably the plug portion forms an outwardly flared flare at an open end.

8. The multifunctional wrench of claim 7, wherein the length of the protrusion is less than or equal to the length of the hollow interior of the plug portion.

9. The multifunctional wrench of claim 1, wherein an end of the driving rod body is in the shape of a regular hexagon, an inner hexagonal socket, or a hexagram.

10. The multifunctional wrench of claim 1, wherein an end of the driving rod body and/or the metal end cap are magnetic.

11. The multifunctional wrench of claim 1, wherein the strength of the metal end cap is greater than or equal to the strength of the reinforcing block.

12. The multifunctional wrench of claim 1, wherein the metal end cap and the reinforcing block are formed as one piece.
